(19) United States
(12) Patent Application Publication
(10) Pub. No.: US 2024/0202682 A1
(43) Pub. Date: Jun. 20, 2024

(54) SYSTEMS AND METHODS FOR INVOICE PAYMENT USING EARNED POINTS

(71) Applicant: JPMORGAN CHASE BANK, N.A., New York, NY (US)

(72) Inventors: Nanda MALLOJHALA, Belle Mead, NJ (US); Matthew HOKE, Audubon, NJ (US); Dave CAREY, Middletown, DE (US); Raghu VUDATHU, Downingtown, PA (US); Michael K. O'LEARY, Garden City Park, NY (US); Kunal MODI, Hockessin, DE (US); Rakhee MANJREKAR, Mumbai (IN); Devron THOMPSON, Plano, TX (US)

(21) Appl. No.: 18/166,106

(22) Filed: Feb. 8, 2023

(30) Foreign Application Priority Data
Dec. 20, 2022 (IN) 202211073804

(51) Int. Cl. G06Q 20/10; G06Q 20/14; G06Q 20/38; G06Q 20/40; G06Q 30/0226; G06Q 30/04

(52) U.S. Cl. CPC G06Q 20/102; G06Q 20/14; G06Q 20/387; G06Q 20/4016; G06Q 30/0233; G06Q 30/04

(57) ABSTRACT

In some aspects, the techniques described herein relate to a method including: receiving a request to initiate an invoice payment, including a customer identifier, an invoice identifier, and a payment amount; determining a number of reward points that is equal to the payment amount; executing a query including the customer identifier as a lookup parameter, where the query returns a number of reward points associated with the customer identifier and an account number; determining that the number of rewards points returned by the query is equal to or greater than the number of reward points that is equal to the payment amount; sending a communication to a payment platform including the demand deposit account number; crediting a demand deposit account associated with the account number with an amount equal to the payment amount; and processing a payment of an invoice by drawing from the demand deposit account.

### RELATED APPLICATIONS

This application claims priority to, and the benefit of, Indian Patent Application No. 202211073804, filed Dec. 20, 2022, the disclosure of which is hereby incorporated, by reference, in its entirety.

### BACKGROUND

### 1. Field of the Invention

Aspects are generally related to systems and methods for invoice payment using earned points.

### 2. Description of the Related Art

Many financial institutions offer credit products such as credit cards and/or credit accounts that allow customers to purchase items on credit and receive an invoice for the amount of credit used on a periodic basis (e.g., a monthly basis). In order to induce consumers into acquiring and using a credit product, many issuers offer rewards that are linked to the use of an issued credit product. Rewards are often granted in the form of “points” that are accumulated based on the amount of charges a customer accumulates on the credit product as reflected in a currency (e.g., dollars). The rewards often have a cash value associated with them, and the cash value may be a percentage of the currency (e.g., a “point” may reflect 1%, or 0.01 dollars.

Conventionally, if a customer of a credit product provider wishes to apply the cash value of earned rewards to an invoice, the providing organization may issue a credit to the periodic invoice that the customer receives. Customers, however, may wish to actually pay an invoice with accumulated reward points, rather than receive a credit that shows up as a line item on the invoice. Many customers may earn enough rewards to make, at least, a minimum required payment to a credit product balance. This may be appealing since a customer may meet a payment obligation with no out of pocket expense. This, however, presents technical challenges to issuers of credit products, since invoices associated with credit products can generally only be electronically paid with a demand deposit account (DDA), and since reward point accounts are not demand deposit accounts.

### SUMMARY

In some aspects, the techniques described herein relate to a method including: receiving, at a payment platform, a request, wherein the request initiates an invoice payment, and wherein the request includes a customer identifier, an invoice identifier, and a payment amount; determining, by a rewards platform, a number of reward points that is equal to the payment amount; executing, by the rewards platform, a query, wherein the query includes the customer identifier as a lookup parameter, and wherein the query returns a number of reward points associated with the customer identifier and a demand deposit account number; determining, by the rewards platform, that the number of reward points returned by the query is equal to or greater than the number of reward points that is equal to the payment amount; sending, by the rewards platform, a communication to the payment platform, wherein the communication includes the demand deposit account number; crediting, by the payment platform, a demand deposit account with a currency in an amount equal to the payment amount, wherein the demand deposit account is associated with the demand deposit account number; and processing a payment of an invoice associated with the invoice identifier in the amount of the payment amount, wherein the payment of the invoice is drawn from the demand deposit account.

In some aspects, the techniques described herein relate to a method, wherein the request is an application programing interface method call.

In some aspects, the techniques described herein relate to a method, wherein the request is received from an electronic device via a public network.

In some aspects, the techniques described herein relate to a method, wherein the request is generated by a computer application executing on the electronic device.

In some aspects, the techniques described herein relate to a method, including: sending request details associated with the request to a fraud platform.

In some aspects, the techniques described herein relate to a method, including: processing the request details associated with the request as input to a fraud engine.

In some aspects, the techniques described herein relate to a method, including: sending, by the fraud platform, an indication that the request is not fraudulent, wherein the request is based on the processing the request details associated with the request as input to the fraud engine.

In some aspects, the techniques described herein relate to a system including at least one computer including a processor, wherein the at least one computer is configured to execute a payment platform and a rewards platform, and wherein the at least one computer is configured to: receive, at the payment platform, a request, wherein the request initiates an invoice payment, and wherein the request includes a customer identifier, an invoice identifier, and a payment amount; determine, by the rewards platform, a number of reward points that is equal to the payment amount; execute, by the rewards platform, a query, wherein the query includes the customer identifier as a lookup parameter, and wherein the query returns a number of reward points associated with the customer identifier and a demand deposit account number; determine, by the rewards platform, that the number of reward points returned by the query is equal to or greater than the number of reward points that is equal to the payment amount; send, by the rewards platform, a communication to the payment platform, wherein the communication includes the demand deposit account number; credit, by the payment platform, a demand deposit account with a currency in an amount equal to the payment amount, wherein the demand deposit account is associated with the demand deposit account number; and process a payment of an invoice associated with the invoice identifier in the amount of the payment amount, wherein the payment of the invoice is drawn from the demand deposit account.

In some aspects, the techniques described herein relate to a system, wherein the request is an application programing interface method call.

In some aspects, the techniques described herein relate to a system, wherein the request is received from an electronic device via a public network.

In some aspects, the techniques described herein relate to a system, wherein the request is generated by a computer application executing on the electronic device.

In some aspects, the techniques described herein relate to a system, wherein the at least one computer is configured to execute a fraud platform and to send request details associated with the request to the fraud platform.

In some aspects, the techniques described herein relate to a system, wherein the at least one computer is configured to process the request details associated with the request as input to a fraud engine.

In some aspects, the techniques described herein relate to a system, wherein the at least one computer is configured send, via the fraud platform, an indication that the request is not fraudulent, wherein the request is based on the processing the request details associated with the request as input to the fraud engine.

In some aspects, the techniques described herein relate to a non-transitory computer readable storage medium, including instructions stored thereon, which instructions, when read and executed by one or more computer processors, cause the one or more computer processors to perform steps including: receiving, at a payment platform, a request, wherein the request initiates an invoice payment, and wherein the request includes a customer identifier, an invoice identifier, and a payment amount; determining, by a rewards platform, a number of reward points that is equal to the payment amount; executing, by the rewards platform, a query, wherein the query includes the customer identifier as a lookup parameter, and wherein the query returns a number of reward points associated with the customer identifier and a demand deposit account number; determining, by the rewards platform, that the number of reward points returned by the query is equal to or greater than the number of reward points that is equal to the payment amount; sending, by the rewards platform, a communication to the payment platform, wherein the communication includes the demand deposit account number; crediting, by the payment platform, a demand deposit account with a currency in an amount equal to the payment amount, wherein the demand deposit account is associated with the demand deposit account number; and processing a payment of an invoice associated with the invoice identifier in the amount of the payment amount, wherein the payment of the invoice is drawn from the demand deposit account.

In some aspects, the techniques described herein relate to a non-transitory computer readable storage medium, wherein the request is an application programing interface method call.

In some aspects, the techniques described herein relate to a non-transitory computer readable storage medium, wherein the request is received from an electronic device via a public network.

In some aspects, the techniques described herein relate to a non-transitory computer readable storage medium wherein the request is generated by a computer application executing on the electronic device.

In some aspects, the techniques described herein relate to a non-transitory computer readable storage medium, including: sending request details associated with the request to a fraud platform.

In some aspects, the techniques described herein relate to a non-transitory computer readable storage medium, including: processing the request details associated with the request as input to a fraud engine; and sending, by the fraud platform, an indication that the request is not fraudulent, wherein the request is based on the processing the request details associated with the request as input to the fraud engine.

### BRIEF DESCRIPTION OF THE DRAWINGS

FIG. 1 is a block diagram of a system for invoice payment using earned points, in accordance with aspects.

FIG. 2 is a logical flow for invoice payment using earned points, in accordance with aspects.

FIG. 3 is a block diagram of a computing device for implementing certain aspects of the present disclosure.

### DETAILED DESCRIPTION

Aspects are generally related to systems and methods for invoice payment using earned points

In accordance with aspects, an issuer of a credit product (i.e., a credit card or credit account) may provide technical services for allowing conversion of reward points to a currency, crediting an amount of currency determined in a conversion process to a demand deposit account, and paying (either partially or fully) an invoice associated with a credit product using the currency in the demand deposit account. Aspects may automate the process, so that a customer is unaware of the generation and crediting of the demand deposit account that will be used to pay the invoice associated with the credit product.

In accordance with aspects, a credit product issuing organization may offer electronic payment of invoices associated with credit products. For example, an issuing organization may provide a frontend interface, such as a website or a mobile application, that is in operative communication with the issuing organization's backend technology infrastructure. The frontend interface may be configured to allow a user to select a payment account from which to pay an invoice associated with a credit product issued by the issuing organization. Additionally, the frontend interface may be configured with a selectable option for paying a credit product invoice with accumulated reward points. The frontend interface may display a number of reward points that a user/customer has accumulated and may further display a currency amount. The currency amount may be the amount of accumulated reward points that the customer has earned multiplied by a conversion factor to arrive at the value, in a currency, of the reward points. For instance, if a customer has accumulated 100,000 reward points based on credit purchases, and the reward points have a cash value of 0.01 dollars, then the frontend interface may display $1000 in reward points that may be credited to an invoice (e.g., 100,000×0.01=$1000). Dollars are used herein as an exemplary currency, but a person having skill in the relevant art would recognize that the techniques described herein are applicable to any currency.

When selected by a user of the interface, an option displayed in a frontend interface for paying an invoice with reward points may trigger a process on an issuing organization's backend that facilitates the payment of a credit product invoice with earned reward points. The frontend interface may initiate an API call to the issuing organization backend. The API call may include a method and the method may take a parameter that includes an indication of the payment method (i.e., a pay-with-points method) and a dollar amount and/or a point amount which to apply against an outstanding invoice. The method may also include a customer identifier (a customer ID) and a credit product identifier (product ID) as parameters. The issuing organization backend may receive the method parameters via an exposed payment API gateway and forward the parameters to a payment engine. A payment engine may be provided for receiving the method call including method parameters from instances of a payment application, or from a payment website, and for processing payments based on the called method and the passed parameters. A payment API gateway and a payment processing engine may be provided by the issuing organization as part of a payment platform.

In accordance with aspects, a payment engine may receive a pay-with-points method call, and based on the pay-with-points method, may initiate pay-with-points method logic. Pay-with-points logic may include method calls to a rewards API gateway provided by the issuing organization as part of a rewards platform. The rewards platform may be configured to manage customer rewards earned through credit product use. A rewards API gateway may also publish a pay-with-points method and may take the same or similar parameters as a pay-with-points method provided by a payment API gateway. A payment engine may pass received parameters to the rewards platform via the API, and the passed parameters may be received by a reward management engine. The reward management engine may, as a result of receiving a pay-with-points method call and corresponding parameters, may initiate pay-with-points logic that is included in the reward management engine.

In addition to a reward management engine, a rewards platform may include a points bank that is a datastore for storing rewards data. Rewards data may include a customer ID and a number of accumulated points associated with a customer ID. A points bank database may also store an account number of a reward linked DDA account that is associated with the customer ID. In accordance with aspects, a reward linked DDA account may be generated and linked to a customer ID when a customer associated with the customer ID completes a setup process for a credit product that is eligible for a pay-with-points payment method. The reward linked DDA may be used as a DDA for funding and debiting by a pay-with-points process. A rewards platform may further include a database of eligibility rules. Pay-with-points logic included in a reward management engine of a rewards platform may receive a pay-with-points method call and included parameters such as a customer ID, a dollar amount, and/or a point number, and a product ID. If a dollar amount and a number of rewards points are received as parameters, the dollar amount may equal the number of reward points according to a defined conversion factor (such as discussed herein).

Reward management engine logic may execute a query of the eligibility rules database and may use the received product ID parameter as a lookup key to retrieve eligibility rules that are associated with the credit product that the product ID represents. The eligibility rules database query may return rules specifying whether the credit product represented by the received product ID is eligible for a pay-with-points process. If the returned eligibility rules indicate that the product ID is not eligible for a pay-with-points process, then a halt-payment message indicating ineligibility may be returned to the payment engine (which may pass the message to the frontend interface for viewing by the customer), and the logic may exit. The halt-payment message may also stop pay-with-points logic executing/waiting at the payment engine. If, on the other hand, the returned eligibility rules indicate the received product ID is eligible for a pay-with-points payment process, then the logic may continue.

Pay with points logic may be in operative communication with a fraud/risk platform and may send payment details to the fraud/risk platform for processing by a fraud/risk engine included in the fraud/risk platform. The fraud/risk platform may receive, from a rewards platform, a payment platform or another platform of the issuing institution, details of the payment request and may use the payment request details as input to the fraud/risk engine. The fraud/risk engine may process the payment request details using fraud/risk rules from a fraud/risk rules database and using other techniques, such as machine learning models that have been trained to recognize fraudulent patterns in payment requests. Output of the fraud/risk engine may include a prediction as to whether the received payment request is fraudulent. If the output prediction is that the received payment request is likely fraudulent (e.g., according to a confidence score), then the fraud/risk platform may return a communication to executing pay-with-point logic indicating likely fraud in the payment request, and the pay-with-point logic may exit. If the out from the fraud risk engine is a prediction of a legitimate payment request, the fraud/risk platform may return a communication indicating that the request is legitimate, and the pay-with-point logic may proceed.

Pay-with-points logic of a reward management engine may also query a points bank database, where the query includes the customer ID as a lookup parameter and returns a number of accumulated reward points associated with the customer ID. Such a query may also return an account number for a reward linked DDA account that is associated with the received customer ID. The reward linked DDA account number may be stored in the point bank database with a relational reference to the customer ID. Pay-with-points logic may make a comparison of the number of reward points returned by the point bank database query to the number of reward points received as a parameter of the pay-with-points method call. If the number of reward points returned by the point bank query is greater than or equal to the number of points received as a parameter of the pay-with-points method, then the logic may continue. If, on the other hand, the number of rewards points returned from the query is less than the number of reward points received as a method parameter (indicating that the customer does not have enough reward points to convert to the desired dollar amount), then the logic may exit and return a halt-payment message to the payment engine. The halt-payment message may indicate that the customer does not have sufficient reward points to make the desired payment. The payment engine may pass the message back to the frontend interface for viewing by the customer, and the halt-payment message may also stop pay-with-points logic executing/waiting at the payment engine.

In a scenario where the points bank query and comparison determine sufficient reward points to proceed, a reward management engine, via pay-with-points logic, may perform an update operation on the reward database that deducts the amount of reward points that is equal to the received dollar amount (converted to a number of points) and/or the received number of reward points from a total number of reward points associated with received customer ID. The pay-with-points logic may then generate a return communication to a payment platform, including return parameters. The return parameters may include the reward linked DDA account number from the query of a points bank database (as discussed, above) and a dollar amount. At this point, the pay-with-points logic of the reward management engine may exit/conclude.

While pay-with-points logic executed by a reward management engine executes, pay-with-points logic executed by a payment engine may wait for a return communication, including parameters, to a method call made to a rewards API gateway. After reward management processing, as discussed above, concludes, a reward management engine may send the expected return communication to the payment engine. The return communication may include a halt-payment message, as discussed above. Alternatively, the return communication may return a reward linked DDA account number from the query of a points bank database (as discussed, above) and a dollar amount as return parameters. If the payment engine receives a halt-payment message, the payment engine may return an error message to the frontend interface that sent the original API call to the payment engine prompting initiation of a pay-with-points method and may exit/conclude processing. If the payment engine receives a reward linked DDA account number and a dollar amount, pay-with-points logic may continue.

When a payment engine receives a reward linked DDA account number and a dollar amount as parameters in a return to an API call, pay-with-points logic of a payment engine may execute additional logic to credit the received account number with a dollar amount equal to the amount received in the return communication. Additionally, pay-with-points logic may initiate payment logic to execute an actual payment with respect to an outstanding invoice associated with a received customer ID, and in an amount as specified in a received API method call parameter. The payment amount may be debited from a reward link DDA account, which is funded via the techniques described above. After a payment with respect to an credit product invoice has been made, pay-with-points logic may send a return communication to the initiating frontend interface including a message indicating that a credit product invoice payment has been successfully made using a customer's reward points.

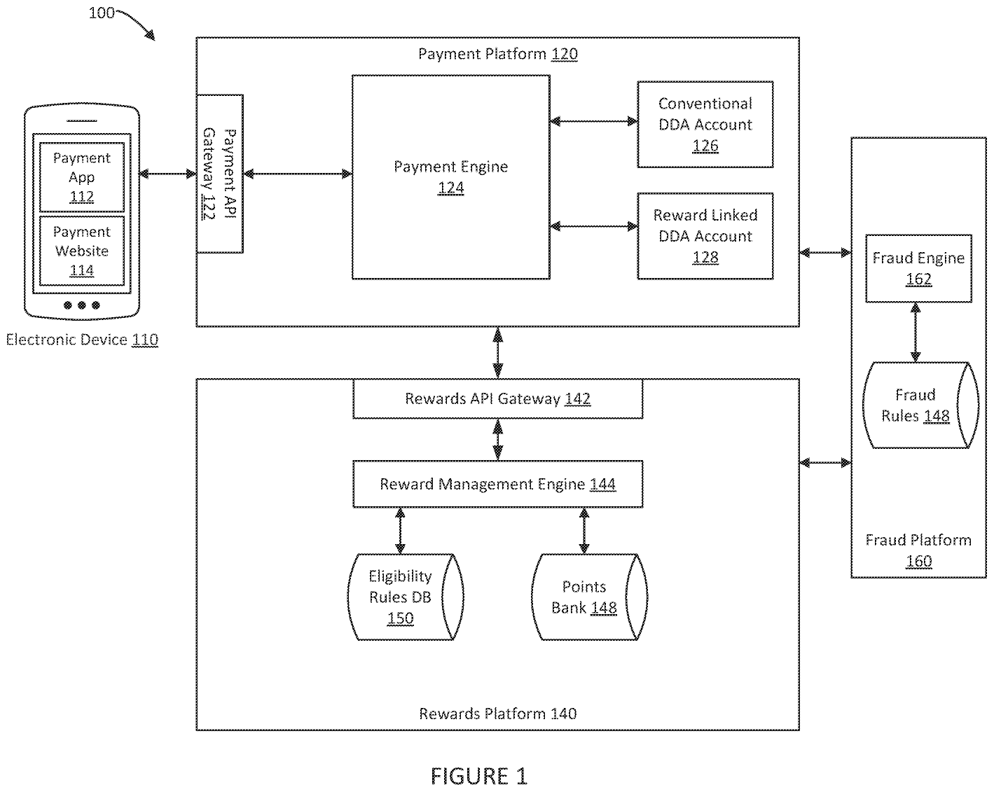

FIG. 1 is a block diagram of a system for invoice payment using earned points, in accordance with aspects. System 100 includes payment platform 120, rewards platform 140, and fraud platform 160. Each of payment platform 120, rewards platform 140 and fraud platform 160 may be part of a technology infrastructure backend of a credit product issuing organization. Such a technology infrastructure can include servers, computers, software applications, computer network mediums, and computer networking hardware and software for providing electronic services based on computer software applications executing on requisite hardware. Exemplary hardware and software include webservers, application servers, database servers and database engines, communication servers such as email servers and SMS servers, network routers, switches and firewalls, custom-developed software applications (i.e., computer applications) including hardware to execute such applications on, etc.

System 100 further includes electronic device 110. Electronic device 110 may be a smart phone, a tablet computer, a laptop computer, or any mobile electronic device that is capable of storing and executing a computer application, such as a mobile application and/or a web browsing application. Electronic device 110, may be communicatively coupled to an issuing organization's technology infrastructure backend via a public network (not shown) with appropriate hardware and software. For instance, electronic device 110 can include a wired or wireless network interface card (NIC) that interfaces with a public network and is configured with appropriate communication protocols. Likewise, a credit product issuer's technology backend may include hardware (NICs, switches, routers, etc.) configured with appropriate protocols for intercommunication with electronic device 110 via a public network.

In accordance with aspects, system 100 may provide one or more application programming interfaces (APIs) in order to facilitate communication with related frontend interfaces and between program modules/engines. Electronic device 110 may communicate with payment platform 120 via payment API gateway 122. Additionally, payment platform 120 may communicate with rewards platform 140 via rewards API gateway 142.

APIs may publish various methods and expose the methods via API gateways. A published API method may be called by an application that is authorized to access the published API methods. API methods may take data as one or more parameters of the called method. API access may be governed by an API gateway associated with a corresponding API. Incoming API method calls may be routed to an API gateway and the API gateway may forward the method calls to internal API servers that may execute the called method, perform processing on any data received as parameters of the called method, and send a return communication to the method caller via the API gateway. A return communication may also include data based on the called method and its data parameters. API gateways may be public or private gateways. A public API gateway may accept method calls from any source without first authenticating or validating the calling source. A private API gateway may require a source to authenticate or validate itself via an authentication or validation service before access to published API methods is granted. APIs may be exposed via dedicated and private communication channels such as private computer networks or may be exposed via public communication channels such as a public computer network (e.g., the internet). APIs, as discussed herein, may be based on any suitable API architecture. Exemplary API architectures and/or protocols include SOAP (Simple Object Access Protocol), XML-RPC, REST (Representational State Transfer), or the like.

Electronic device 110 executes payment app 112 and payment website 114 (displayed through a website browsing application). Payment app 112 is a computer application such as a mobile application. Payment website 114 is a website hosted by payment platform 120 and displayed at electronic device 110 through a website browsing application. Both payment app 112 and payment website 114 facilitate initiation of pay-with-points logic via a method call to payment API gateway 122 as discussed in detail, herein.

Payment engine 124 executes pay-with-points logic, in accordance with aspects. Payment engine 124 may be embodied as computer software executing on requisite hardware. Payment engine 124 may receive an API method call from payment API gateway 122 where the method call invokes a pay-with-points method that is executed by payment engine 124. The method may pass parameterized data to payment engine 124, such as an indication of the payment method (i.e., a pay-with-points payment), a dollar amount and/or a point amount which to apply against an outstanding invoice, an invoice ID, a customer identifier (a customer ID) and a credit product identifier (product ID) as parameters.

Payment platform 120 may also maintain/house or be in operative communication with DDA accounts that can be used for electronic invoice payments of credit product invoices. Payment platform 120 may include conventional DDA account 126 and reward linked DDA account 128. Conventional DDA account 126 may be a DDA account that is associated with a customer such as a savings or checking account. Reward linked DDA account 128 may also be a DDA account with properties similar to a conventional DDA account, such that it may be used as a payment source in an electronic payment process. Reward linked DDA account 128, however, may be generated as part of a credit product issuing process, and may be accessible by payment engine 124.

Payment engine 124 may, as part of a pay-with-points logic, call a pay-with-points method published by rewards API gateway 142. The pay-with-points method, including pay with points logic, may be executed by reward management engine 144. The pay with points method of reward management engine 144 may receive parameterized data such as an indication of the payment method (i.e., a pay-with-points payment), a dollar amount and/or a point amount which to apply against an outstanding invoice, an invoice ID, a customer identifier (a customer ID) and a credit product identifier (product ID) as parameters. The parameters may be forwarded from payment engine 124 as necessary.

Reward management engine 144 may receive the parameters and may query eligibility rules DB 150 in order to determine eligibility of the relevant credit product for the called pay-with-points method, as described herein. Eligibility rules DB 150 may be a database engine executing an appropriate data store (e.g., a relational database) on requisite hardware. Eligibility rules DB 150 may be any suitable datastore. Eligibility rules DB 150 may store eligibility rules for credit products issued by an issuing organization.

Reward management engine 144 may also query points bank 148. Points bank 148 is a may be a database engine executing an appropriate data store (e.g., a relational database) on requisite hardware. Points bank 148 may be any suitable datastore. Reward management engine 144 may query points bank 148 using a received customer ID as a lookup key, and the query may return a number of reward points associated with the received customer ID. The query may also return an account number for a reward linked DDA account (e.g., reward linked DDA account 128) that is associated with the received customer ID. The reward linked DDA account number may be stored in points bank 148 with a relational reference to the customer ID. Reward management engine 144 may make a comparison of the number of reward points returned by the point bank database query to the number of reward points received as a parameter of the pay-with-points method call. If the number of reward points returned by the point bank query is greater than or equal to the number of points received as a parameter of the pay-with-points method, then reward management engine 144 may generate a return communication to payment engine 124 including parameters.

Either payment engine 124 or reward management engine 144 may invoke fraud engine 162 of fraud platform 160 in order to perform a fraud/risk analysis of the received payment request. Fraud engine 162 may include models (such as machine learning models) that have been trained to recognize fraudulent patterns in payment requests and tag such requests as fraudulent. Fraud engine 162 may be in operative communication with fraud rules 148. Fraud rules 148 is a database of conditional rules for use in algorithmic decisioning of fraud in payment requests. Fraud engine 162 may receive payment request details and may process the payment request details as input to a fraud detection process and may return a decision as to whether the requested payment is fraudulent.

In accordance with aspects, a return communication from reward management engine 144 to payment engine 124 may include the reward linked DDA account number from the query of points bank 148 and a dollar amount as return parameters. Upon receipt these parameters in a return communication, payment engine 124 may fund reward linked DDA account 128 with the received dollar amount from the return communication. Payment engine 124 may then send a message to electronic device 110 indicating that a payment has successfully been made using earned reward points.

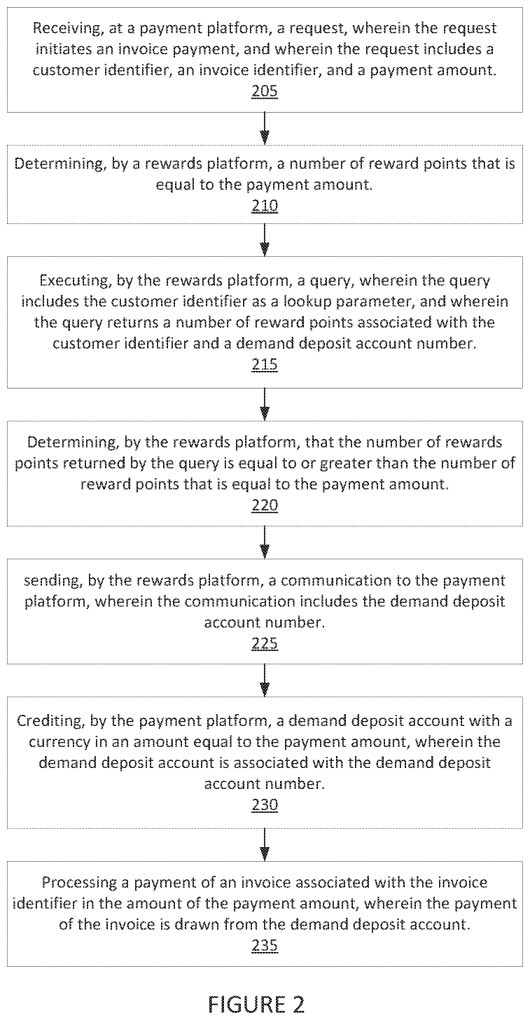

FIG. 2 is a logical flow for invoice payment using earned points, in accordance with aspects.

Step 205 includes receiving, at a payment platform, a request, wherein the request initiates an invoice payment, and wherein the request includes a customer identifier, an invoice identifier, and a payment amount.

Step 210 includes determining, by a rewards platform, a number of reward points that is equal to the payment amount.

Step 215 includes executing, by the rewards platform, a query, wherein the query includes the customer identifier as a lookup parameter, and wherein the query returns a number of reward points associated with the customer identifier and a demand deposit account number.

Step 220 includes determining, by the rewards platform, that the number of rewards points returned by the query is equal to or greater than the number of reward points that is equal to the payment amount.

Step 225 includes sending, by the rewards platform, a communication to the payment platform, wherein the communication includes the demand deposit account number.

Step 230 includes crediting, by the payment platform, a demand deposit account with a currency in an amount equal to the payment amount, wherein the demand deposit account is associated with the demand deposit account number.

Step 235 includes processing a payment of an invoice associated with the invoice identifier in the amount of the payment amount, wherein the payment of the invoice is drawn from the demand deposit account.

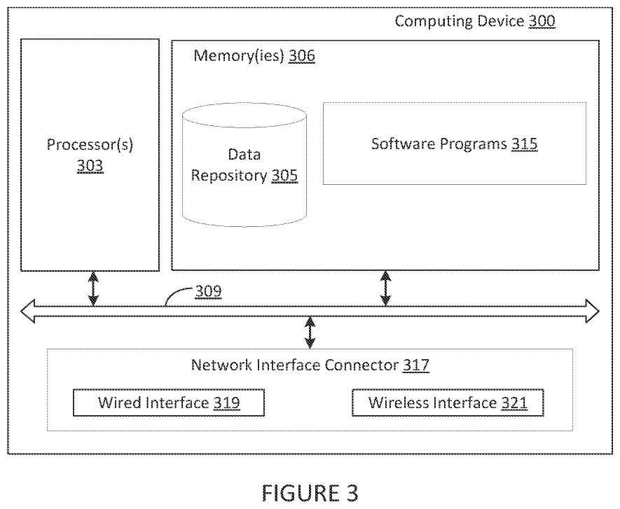

FIG. 3 is a block diagram of a computing device for implementing certain aspects of the present disclosure. FIG. 3 depicts exemplary computing device 300. Computing device 300 may represent hardware that executes the logic that drives the various system components described herein. For example, system components such servers, database engines, processing engines, electronic devices, and various other components of an organization's technology infrastructure backend, may include, and/or execute on, components and configurations like, or similar to, computing device 300. Computing device 300 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which can be executed by processor 303. Memory 306 may also include data repository 305, which may be nonvolatile memory for data persistence. The processor 303 and the memory 306 may be coupled by a bus 309. In some examples, the bus 309 may also be coupled to one or more network interface connectors 317, such as wired network interface 319, and/or wireless network interface 321. Computing device 300 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a micro-processor and/or in the form of statically or dynamically programmed electronic circuitry.

Hereinafter, general aspects of implementation of the systems and methods of the invention will be described.

The system of the invention or portions of the system of the invention may be in the form of a “processing machine,” “computing device” or an “electronic device” such as a general-purpose computer, a computer server, a host machine, etc. As used herein, the term “processing machine,” “computing device,” “electronic device,” etc., is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a “program,” “software program,” “application,” “computer application,” “software,” or the like. In one aspect, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some aspects of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method comprising:
receiving, at a payment platform, a request, wherein the request initiates an invoice payment, and wherein the request includes a customer identifier, an invoice identifier, and a payment amount;
determining, by a rewards platform, a number of reward points that is equal to the payment amount;
executing, by the rewards platform, a query, wherein the query includes the customer identifier as a lookup parameter, and wherein the query returns a number of reward points associated with the customer identifier and a demand deposit account number;
determining, by the rewards platform, that the number of reward points returned by the query is equal to or greater than the number of reward points that is equal to the payment amount;
sending, by the rewards platform, a communication to the payment platform, wherein the communication includes the demand deposit account number;
crediting, by the payment platform, a demand deposit account with a currency in an amount equal to the payment amount, wherein the demand deposit account is associated with the demand deposit account number; and
processing a payment of an invoice associated with the invoice identifier in the amount of the payment amount, wherein the payment of the invoice is drawn from the demand deposit account.

2. The method of claim 1, wherein the request is an application programing interface method call.

3. The method of claim 2, wherein the request is received from an electronic device via a public network.

4. The method of claim 3, wherein the request is generated by a computer application executing on the electronic device.

5. The method of claim 1, comprising:
sending request details associated with the request to a fraud platform.

6. The method of claim 5, comprising:
processing the request details associated with the request as input to a fraud engine.

7. The method of claim 6, comprising:
sending, by the fraud platform, an indication that the request is not fraudulent, wherein the request is based on the processing the request details associated with the request as input to the fraud engine.

8. A system comprising at least one computer including a processor, wherein the at least one computer is configured to execute a payment platform and a rewards platform, and wherein the at least one computer is configured to:
receive, at the payment platform, a request, wherein the request initiates an invoice payment, and wherein the request includes a customer identifier, an invoice identifier, and a payment amount;
determine, by the rewards platform, a number of reward points that is equal to the payment amount;
execute, by the rewards platform, a query, wherein the query includes the customer identifier as a lookup parameter, and wherein the query returns a number of reward points associated with the customer identifier and a demand deposit account number;
determine, by the rewards platform, that the number of reward points returned by the query is equal to or greater than the number of reward points that is equal to the payment amount;
send, by the rewards platform, a communication to the payment platform, wherein the communication includes the demand deposit account number;
credit, by the payment platform, a demand deposit account with a currency in an amount equal to the payment amount, wherein the demand deposit account is associated with the demand deposit account number; and
process a payment of an invoice associated with the invoice identifier in the amount of the payment amount, wherein the payment of the invoice is drawn from the demand deposit account.

9. The system of claim 8, wherein the request is an application programing interface method call.

10. The system of claim 9, wherein the request is received from an electronic device via a public network.

11. The system of claim 10, wherein the request is generated by a computer application executing on the electronic device.

12. The system of claim 8, wherein the at least one computer is configured to execute a fraud platform and to send request details associated with the request to the fraud platform.

13. The system of claim 12, wherein the at least one computer is configured to process the request details associated with the request as input to a fraud engine.

14. The system of claim 13, wherein the at least one computer is configured send, via the fraud platform, an indication that the request is not fraudulent, wherein the request is based on the processing the request details associated with the request as input to the fraud engine.

15. A non-transitory computer readable storage medium, including instructions stored thereon, which instructions, when read and executed by one or more computer processors, cause the one or more computer processors to perform steps comprising:
receiving, at a payment platform, a request, wherein the request initiates an invoice payment, and wherein the request includes a customer identifier, an invoice identifier, and a payment amount;
determining, by a rewards platform, a number of reward points that is equal to the payment amount;
executing, by the rewards platform, a query, wherein the query includes the customer identifier as a lookup parameter, and wherein the query returns a number of reward points associated with the customer identifier and a demand deposit account number;
determining, by the rewards platform, that the number of reward points returned by the query is equal to or greater than the number of reward points that is equal to the payment amount;
sending, by the rewards platform, a communication to the payment platform, wherein the communication includes the demand deposit account number;
crediting, by the payment platform, a demand deposit account with a currency in an amount equal to the payment amount, wherein the demand deposit account is associated with the demand deposit account number; and
processing a payment of an invoice associated with the invoice identifier in the amount of the payment amount, wherein the payment of the invoice is drawn from the demand deposit account.

16. The non-transitory computer readable storage medium of claim 15, wherein the request is an application programing interface method call.

17. The non-transitory computer readable storage medium of claim 16, wherein the request is received from an electronic device via a public network.

18. The non-transitory computer readable storage medium of claim 17 wherein the request is generated by a computer application executing on the electronic device.

19. The non-transitory computer readable storage medium of claim 15, comprising:
sending request details associated with the request to a fraud platform.

20. The non-transitory computer readable storage medium of claim 19, comprising:
processing the request details associated with the request as input to a fraud engine; and
sending, by the fraud platform, an indication that the request is not fraudulent, wherein the request is based on the processing the request details associated with the request as input to the fraud engine.
